(19) United States
(12) Patent Application Publication
(10) Pub. No.: US 2017/0171140 A1
(43) Pub. Date: Jun. 15, 2017

(54) PLATFORM FOR DIGITAL BUSINESS CARDS THAT FACILITATES CONNECTIONS BETWEEN INDIVIDUALS AND A METHOD THEREOF

(71) Applicants: Jose Somarriba, Phillips Ranch, CA (US); Nidia Anleu Guzman, Pasadena, CA (US)

(72) Inventors: Jose Somarriba, Phillips Ranch, CA (US); Nidia Anleu Guzman, Pasadena, CA (US)

(73) Assignee: Kartomi, Inc., Los Angeles, CA (US)

(21) Appl. No.: 15/249,227

(22) Filed: Aug. 26, 2016

Related U.S. Application Data
(60) Provisional application No. 62/206,208, filed on Aug. 17, 2015.

(51) Int. Cl. H04L 12/58; H04L 29/08

(52) U.S. Cl. CPC H04L 51/32; H04L 67/306; H04L 51/28

(57) ABSTRACT

The present disclosure relates to creating a mobile application that can convert a digital business card in a global business network which enables the more efficient connection of business personnel and their associated information into manageable data in a global business network. More specifically disclosed is a mobile application with enhanced information connectivity through the use of a digital business card which is loaded with various packets of data based on the user's preference and is converted and integrated into a global business network.

### CROSS-REFERENCE TO RELATED PATENT APPLICATIONS

Embodiments of the present invention relate to U.S. Provisional Application Ser. No. 62/206,208, filed Aug. 17, 2015, entitled “METHOD AND APPLICATIONS FOR CONNECTING AND CONVERTING BUSINESS CARDS AND LEADS IN TO A GLOBAL BUSINESS NETWORK”, the contents of which are incorporated by reference herein in its entirety and which is a basis for a claim of priority.

### FIELD OF THE INVENTION

The present invention is in the field of connecting business personnel and their associated information into manageable data in a global business network. More specifically, the present disclosure provides a platform that facilitates connections between individuals through digital business cards and transforms a new contact into a lasting relationship.

### BACKGROUND

In the United States, about 10 billion business cards are printed every year. Among those printed business cards, about 88% of them are tossed within a week after they are handed out and become garbage. It also takes an average of 2,000 business cards just to get a 2.5% increase for company sales. According to a survey, 63% of surveyees indicate the top reason they toss away business cards is because they don't need the service provided by the card giver and 24% say they plain don't want to do business with the specific card giver.

In the last few years, a variety of digital business cards have been introduced to reduce the usage of printed business cards. However, they still suffer the same drawbacks, most of them got “toss away” (i.e., deleted) after they were distributed because people either don't need the service or don't want to do the business with the specific card giver. In addition, conventional digital business cards simply provide a person's business information to another person and do not facilitate any connections between them. Thus, a lot of potential business opportunities are lost because most people fail to follow up with each other after they exchanged business information.

Accordingly, there exists a need for an improved platform for digital business cards that facilitates the transformation of new contact into a lasting relationship.

### SUMMARY OF THE DISCLOSURE

The embodiments of the present invention generally relate to connecting business personnel and their associated information into manageable data in a global business network and more specifically with information connectivity through a mobile application or software format via the use of a digital business card which is loaded with various packets of data based on the users' preference and is converted and integrated into a global business network.

In accordance with one embodiment of the present disclosure, a platform is disclosed comprising a non-transitory computer-readable storage medium comprising programmable instructions adapted to be executed on one or more processors, and to perform a method of: 1) allowing a plurality of users to register and create their own profiles on a platform server, wherein each user's profile includes at least a business profile and a personal profile; 2) allowing a first user within the plurality of users to search and have access to a second user's business profile and personal profile, where the second user's business profile and personal profile are found and accessed by the first user through match reference set by the first user, ID search, name search, QR code scan search, email search or combination thereof; 3) allowing the first user to add the second user to the first user's contact list and make notes regarding the second user; 4) displaying a countdown bar beside the second user's name in the first user's contact list or on the second user's business profile or personal profile once the first user adds the second user into the first user's contact list, where the countdown bar displays a specified time which the first user needs to initiate a contact with the second user; 5) allowing the first user to send message to the second user and share news or articles with the second user or allowing the first user to receive message from the second user to initiate the contact; and 6) archiving the second user from the first user's contact list if the first user did not initiate the contact with the second user within the specified time and the second user did not initiate contact with the first user within the specified time as well.

The foregoing and other objects, features and advantages of the present invention are more readily apparent from the detailed description of the preferred embodiments set forth below, taken in conjunction with the accompanying drawings.

### BRIEF DESCRIPTION OF THE DRAWINGS

FIG. 1 is a schematic drawing according to an exemplary embodiment of the present invention.

FIG. 2 is a schematic drawing according to an exemplary embodiment of the present invention.

FIG. 3 is a schematic drawing according to an exemplary embodiment of the present invention.

FIG. 4 is a schematic drawing according to an exemplary embodiment of the present invention.

FIG. 5 is a schematic drawing according to an exemplary embodiment of the present invention.

FIG. 6 is a schematic drawing according to an exemplary embodiment of the present invention.

FIG. 7 is a schematic drawing according to an exemplary embodiment of the present invention.

FIG. 8 is a schematic drawing according to an exemplary embodiment of the present invention.

FIG. 9 is a schematic drawing according to an exemplary embodiment of the present invention.

FIG. 10 is a schematic drawing according to an exemplary embodiment of the present invention.

FIG. 11 is a schematic drawing according to an exemplary embodiment of the present invention.

### DETAILED DESCRIPTION OF PREFERRED EMBODIMENTS

The following description is not to be taken in a limiting sense, but is made merely for the purpose of illustrating the general principles of the invention, since the scope of the invention is best defined by the following claims. Various inventive features are described below that can each be used independently of one another or in combination with other features.

Broadly, embodiments of the present disclosure generally provide a platform for digital business cards that facilitates the transformation of new contact into a lasting relationship. The platform can be accessed by a mobile device (e.g., mobile phone) through a mobile application or by a computer through computer software or internet browsers.

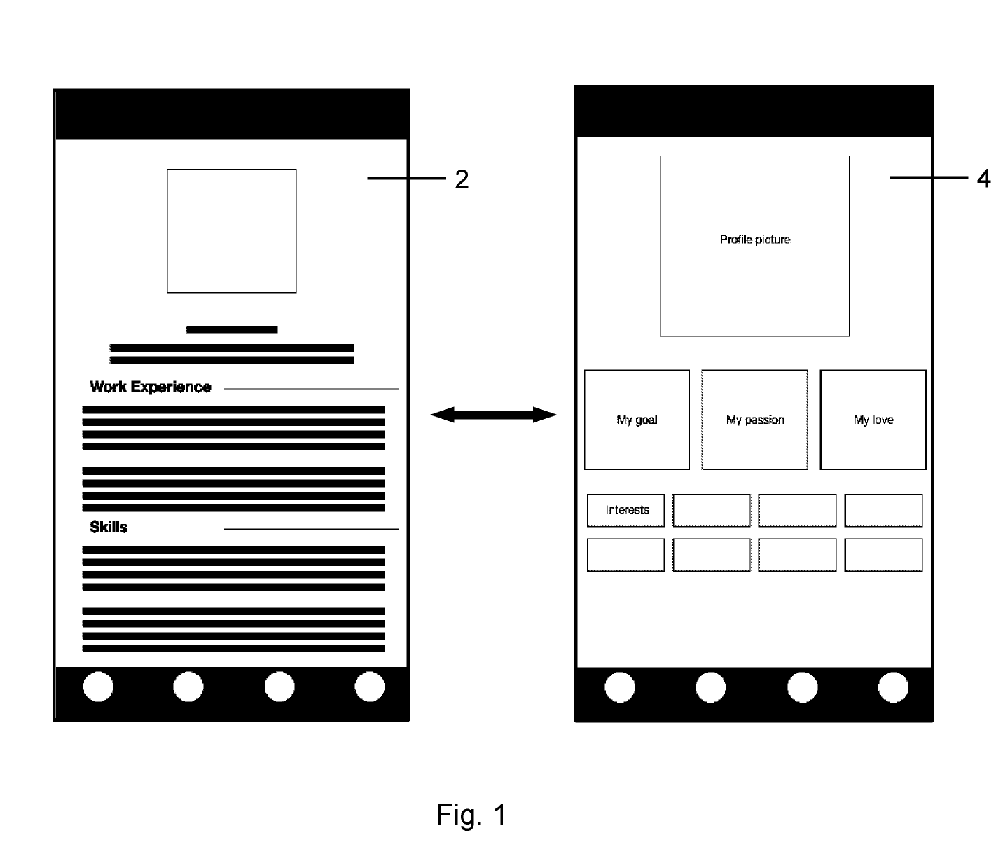

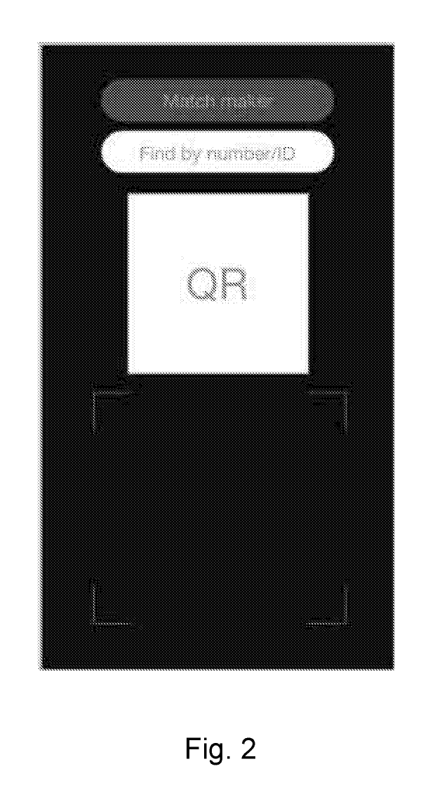

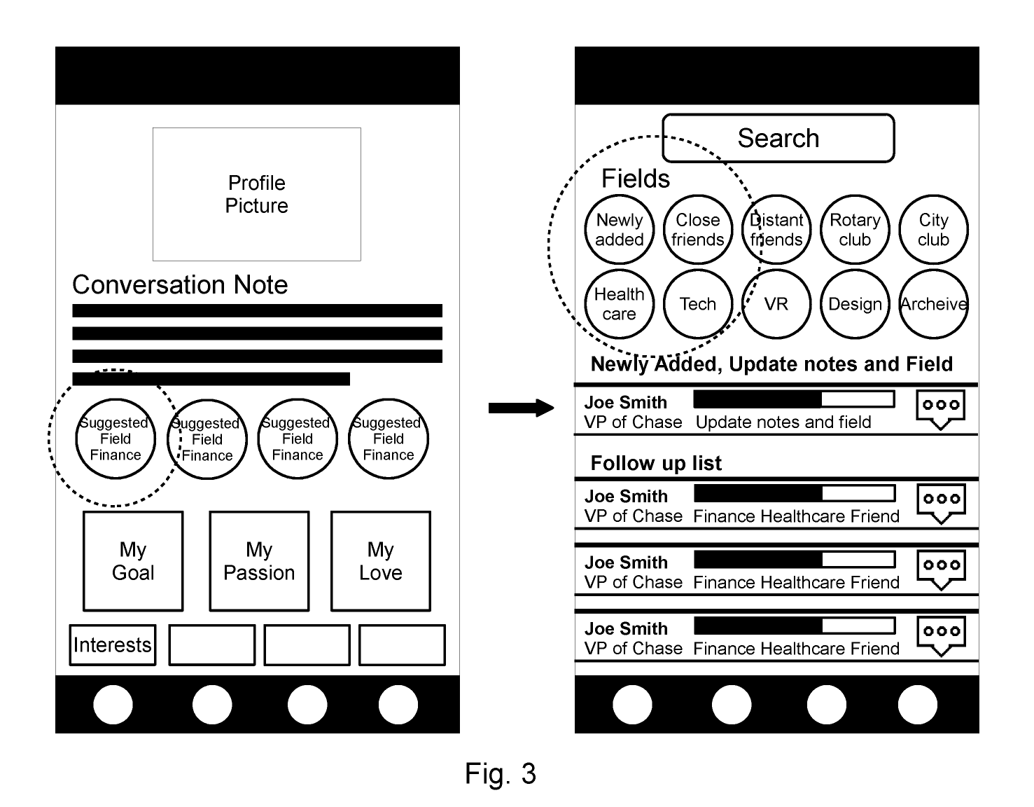

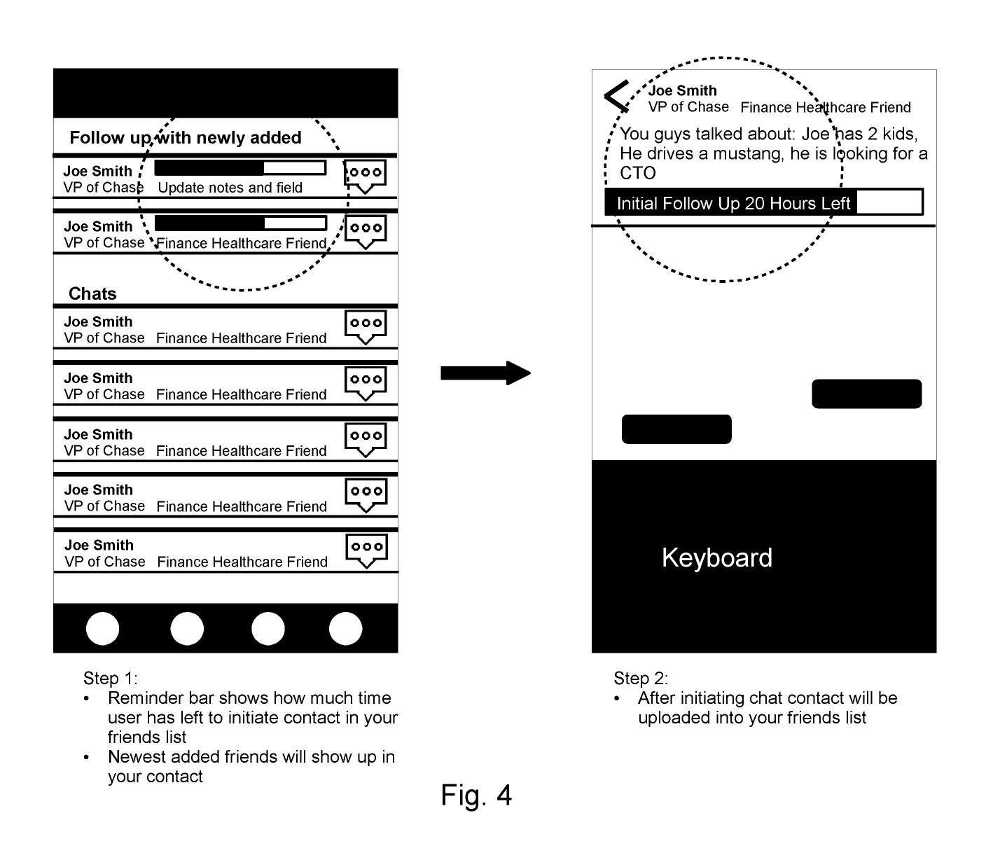

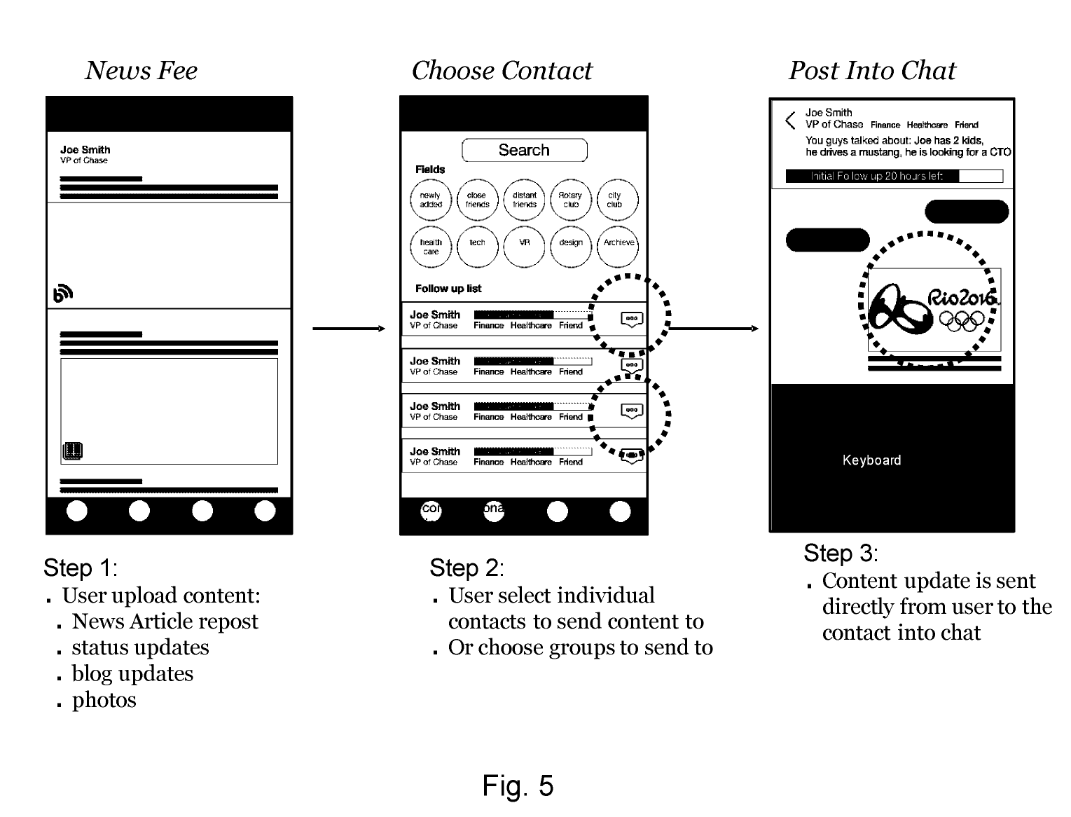

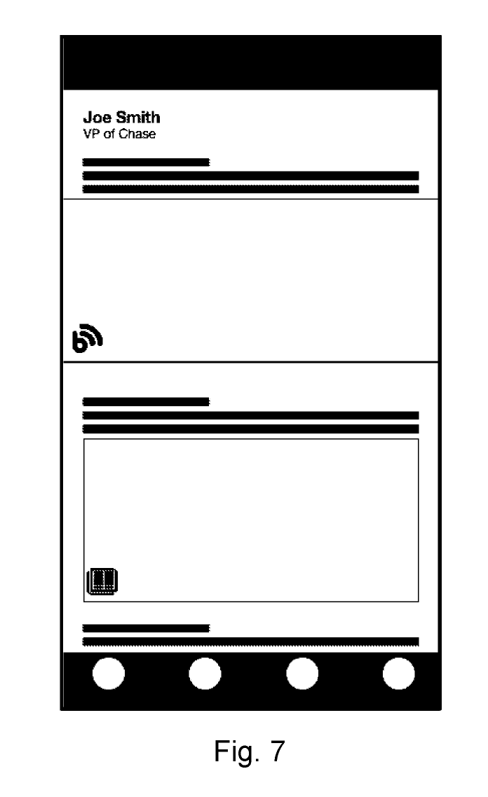

In accordance with one aspect of at least one embodiment of the present disclosure, the disclosed platform (or application) comprises a non-transitory computer-readable storage medium comprising programmable instructions adapted to be executed on one or more processors, and to perform a method of: allowing a plurality of users to register and create their own profiles on a platform server, wherein each user's profile includes at least a business profile (i.e., digital business card) 2 and a personal profile 4 as shown by FIG. 1; allowing a first user within the plurality of users to search and have access to a second user's business profile 2 and personal profile 4, where the second user's business profile 2 and personal profile 4 are found and accessed by the first user through match reference set by the first user, ID search, name search, QR code scan search, email search or combination thereof as shown by FIG. 2; allowing the first user to add the second user to the first user's contact list and make notes regarding the second user as shown by FIG. 3; displaying a countdown bar beside the second user's name in the first user's contact list or on the second user's business profile 2 or personal profile 4 once the first user adds the second user into the first user's contact list, where the countdown bar displays a specified time which the first user needs to initiate a contact with the second user as shown by FIG. 4; allowing the first user to send message to the second user and share news or articles (as shown by FIG. 7) with the second user or allowing the first user to receive message from the second user to initiate the contact as shown by FIG. 5; and archiving the second user from the first user's contact list if the first user did not initiate the contact with the second user within the specified time and the second user did not initiate contact with the first user within the specified time as well. Users will have to reinitiate contact to unlock achieved connections

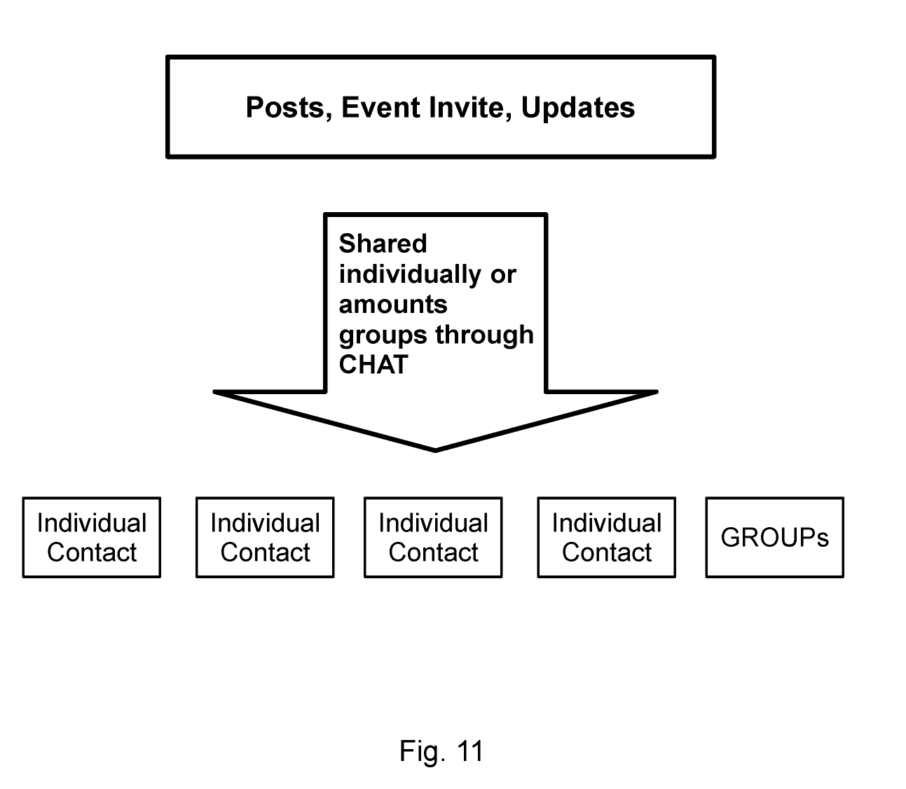

Preferably, the specified time to initiate contact or follow up should be twenty-four (24), forty-eight (48) or seventy-two (72) hours etc. The platform also allows the user to set additional notice after the expiration of specified time or after a message or post is sent to the second user (e.g., 3 days' post follow up, and if not correctly followed, the contact will be archived). In addition, the first user can send the message to the second user either directly by individual chat or send the message to the contact group which the second user is assigned, where everyone in the contact group including the second user will receive the same message as shown by FIG. 11.

As illustrated by FIG. 4, the follow-up (or initiate contact) feature facilitate or prompt a user to make contact to a person he or she just added. For example, and not by way of limitation, the platform can be configured in a way that user and new contact must initiate conversation within 24 hours to add the new contact into a friend list. If the two parties do not exchange chat then the new contact will be achieved. Archived contacts can still be reconnected, however new add process has to be initiated. This encourages users to build rapport within the specified time (e.g, 24 hours).

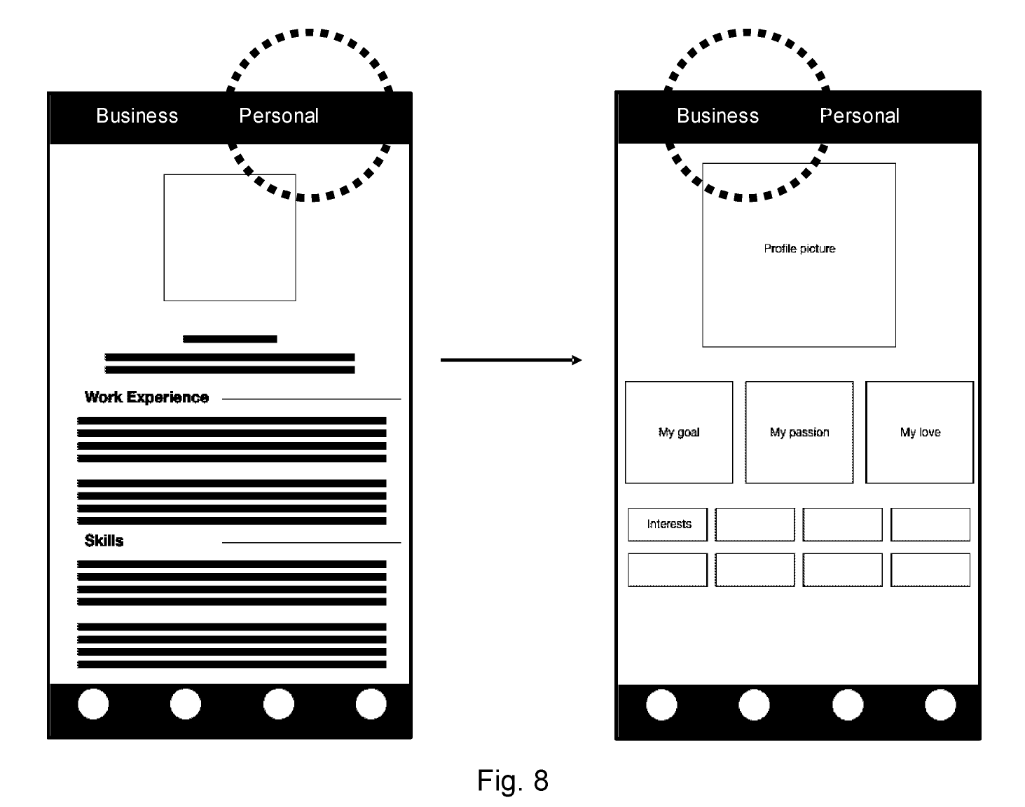

As illustrated by FIG. 1, the business profile 2 functions like a digital business card and displays at least the user's photo (preferably a formal business photo), name, job title work experience and skill. The disclosed platform allows the user to create new business profile 2 from scratch, or incorporating it from other digital business card server/service such as LinkedIn®. The personal profile 4 displays at least each user's photo (preferably a more causal and non-business photo), interest and other personal life information which the user would like to share. One purpose of creating two profiles is to allow a potential contact to know the user's business side and personal side. As shown by FIG. 8, the business profile 2 and the personal profile 4 can be displayed via a mobile device and switched by a user through business and personal tabs on the top.

In one embodiment of the present disclosure, the platform automatically assigns a newly added contact, such as the second user, into at least one contact group in the first user's contact list based on the second user's business profile or personal profile. The first user can also manually assign the second user into at least one contact group. For example, when a new contact is added by the first user, the new contact will be placed in an appropriate category such as close friends, technology, healthcare etc. Users will select their own category streamline the process and they can also make changes and addition to it. The platform may also automatically update the categories depending on the users' habit of finding contacts.

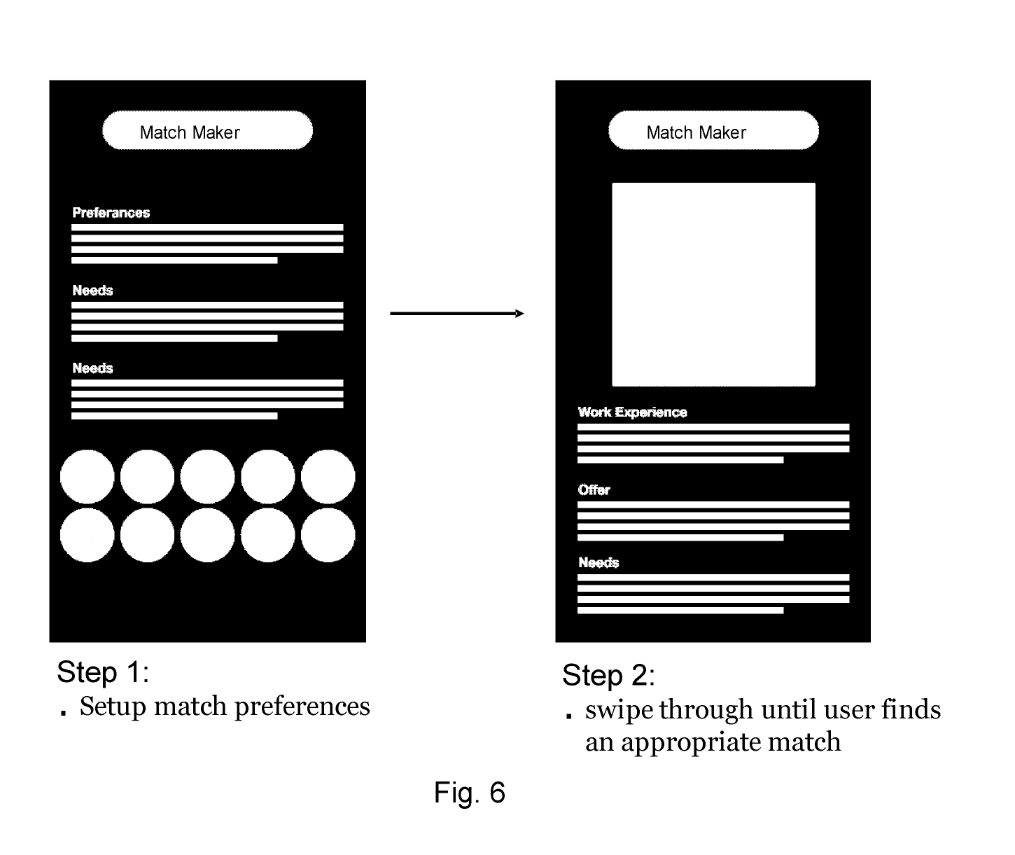

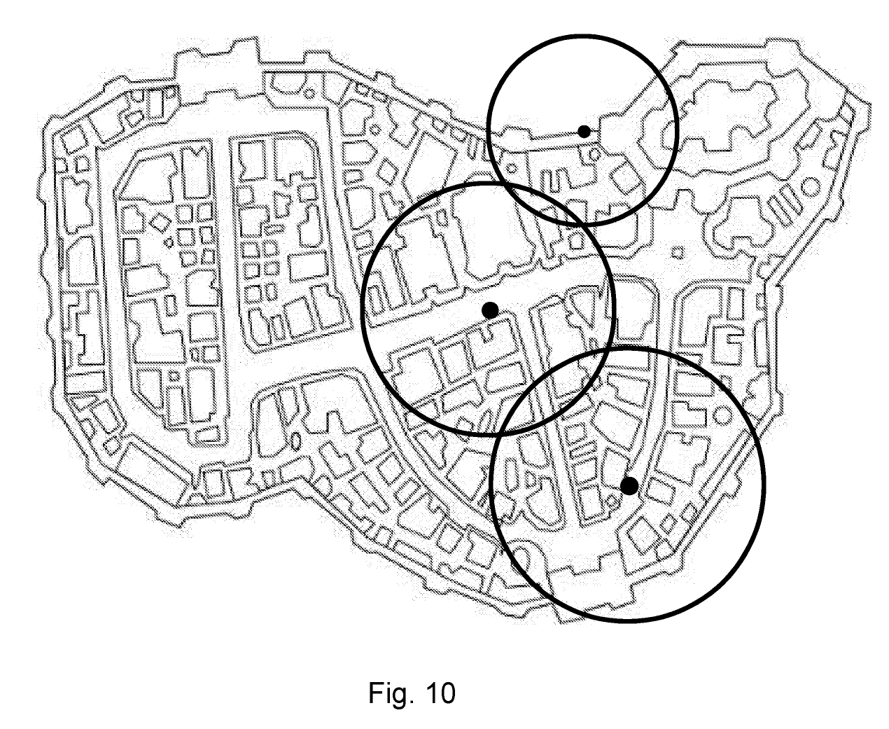

As shown by FIG. 6, the platform also provides match reference setting that allows the first user to search other users within the plurality of users based on their distances or radius on a map (as shown by FIG. 10), expert fields, company sizes, types of business relationship, experiences or combination thereof of For example, the platform can be configured to provide match making that suggests friends and potential business partners. It can also provide users with a list of attendees to an event. So an attendee can do research on a potential participants or connect with people they did not have to chance to talk to.

In yet another embodiment of the present disclosure, the platform is capable of determining whether to display second user's business profile first or his or her personal profile first based on the first user's member status, search habit, search criteria and goal etc. For example, and not by way of limitation, the platform allows different users to have an adjusted UX setup for maximization and efficiency (e.g., Posters, Networkers and Fee Explorers etc.). Poster—first page start at active camera with instant type upload; Networkers—will start on add contact page and also extra features in organizing contacts; Fee Explorers—will start on feed with additional features.

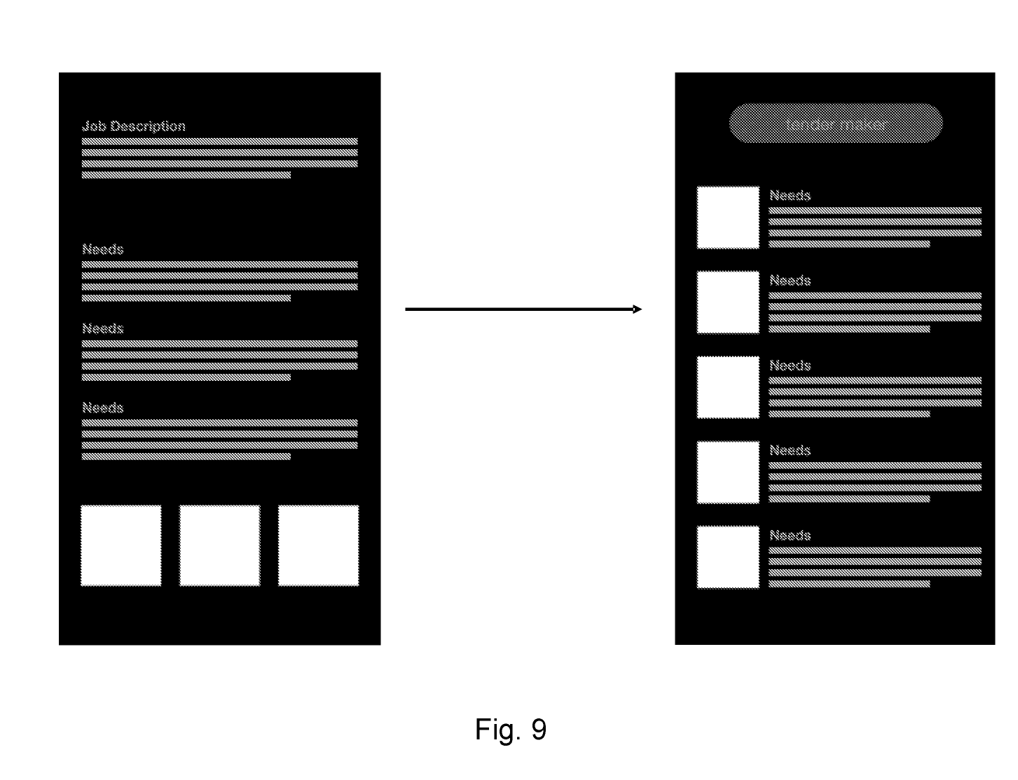

In yet another embodiment of the present disclosure, as shown by FIG. 9, the platform further comprises a job tendering/matching making feature. This allows a user or company to auction out jobs for tenders. This will be very effective for conventions. For instance, a company or user can set up job description RFP, upload potential images and describe job needs. Then close by users will be able to bid on your job and make potential offer/connection.

In yet another embodiment of the present disclosure, the platform further provides a calendar to its user that allows the first user to create or search for an event, and to invite another user to the event. It also allows in person meeting setup. Users may also see the chronological reference to their personal relationships.

In yet another embodiment of the present disclosure, the platform further connects to other modular applications via backend so that profiles, contacts, chats and interactions can be shared depending on the applications functionality (e.g., Convention App, Business Professoinal Social Media Network, Money Transfer, Business IM, Business Communication, Human Resource Headhunting etc.).

For example, a business integration application (or platform) can be created to serve as the hub for interconnecting the various aspects along the chain in a business relationship. The chain may include features such as security, digital card, networking, business meeting, temporary files and processes. In this case users may use the application to create a digital card which is then used for networking; setting up business meetings, and storing information related to companies and or any business type features. One area identified in this example relates to security which may relate to the level of encryption related to data transfer with a certain company or individual or may relate to blocking certain requests for information or other forms of security necessary in a business and/or digital setting. Another relates to information about the users and what information they want to provide and to whom. Another feature relates to a digital card which may be loaded with various packets of data and information which may be selectively shared and protected based on a user's preference. Another feature relates to the networking which may relate to how information is exchanged or attained from various businesses or individuals. Another feature relates to a business meeting feature which may have capabilities to review schedules, locations and identify potential participants and assist with creating a business meeting time, place and persons. Another feature relates to having a customizable area for the users to provide certain information or to manage certain aspects of either their business card or their relationship with the application itself in the Temporary Files area. And a last identified feature in this example relates to the various processes that may be run in combination with the application and the business card or with the business card alone.

The security features identified above enables various security settings for the registered users. The security system may protect passwords and/or also be password protected at various feature interactions. For example, when a user is entering payment information for a transaction online various additional security features may be activated to provide greater encryption. Other security features may be in place to protect individual users and/or companies account information related to the application and their information shared with the global business network.

The users' features identified above enables access to the individual user's information that the individual can choose whether or not to share with others within the network. The exemplary information relates to data and information regarding their personal life including financial and or social information; information regarding their employment status, company, history and the like; information related to their physical location for work, home or at a specific time with a GPS type positioning; and a photo or other information.

The digital business card features identified above enables individual users or businesses to design the various features and security aspects of the data related to their card. The features to be designed can include design features; what amount of data to put on the card; the logo information; and the card validation process.

The networking features identified above enables the individual user or company to identify and select how they want to interact socially and or businesswise using the internet, cloud or any other social media type interaction platform. Exemplary preferences in the networking section include the invitation and or labeling of contacts as friends, and/or as professional relations. Additional information is available to target specific communities and or specific interests for targeted type networking features.

The business meeting features identified above enables the individual users or businesses with services for more efficiently identifying personnel, contacts, locations and available times for scheduling business meetings. The application may provide a suggestion as to a best location based on the locations of the individuals or businesses planning on attending. The application may further review schedules of suggested participants and target a time and day when all appear to have time. Additional features may include information for important notes regarding the meeting and or additional services such as extra materials needed e.g. room wi-fi, projector capabilities or teleconference capabilities. Embodiments generally include any information which assist with the rapid identification of various times, locations or other information necessary to successfully plan a business meeting.

The temporary files features identified above enables individual users or company users to control and or file various aspects of the application. Some categories included in this temporary files section include an app processes feature which enables the user to personalize various aspects of the application processes; a recovery function which enables the user to take steps for recovering information or the application if necessary; a “while use” function which enables the user to control what functions and features of the application may be used, changed, or modified while in use; a no internet function which enables the user to block internet aspects of the application; and a spam detection feature for blocking unsolicited information.

The processes features identified above enables processes of the embodied application wherein the individual users or company users are able to control the information, storage and memory aspects of the associated data received and manage the resources of the application itself. The exemplary functions listed in the Processes section includes: the control of how data and information may be stored in databases; how information may be extracted from either the global business network, the e-business card or general other profile information available electronically; the control of the device resource consumption; and control of memory allocation within the application, mobile device, e-business card or global business network.

The advantages of the present disclosure include the ability to more effectively utilize an enhanced digital business card loaded with various packets of data or security features to improve and better manage connections with individuals and companies through a global business network application. The embodiments of the present invention allow the users of the embodied application to design their own card and share it with their contacts, and can expand their contacts according to the industries in which the user participates. Additional aspects allow for the global business network to utilize the embodied application to help establish a schedule of activities that is synchronized with the user's contacts, and can recommend times and places to hold meeting, among other exemplary functions. Another additional aspect includes an enterprise version wherein individual companies utilizing the embodied application are able to predetermine or grant approval for individual users, or business groups to use or incorporate the business logo and/or other business related data into the design of their card.

The platform also provides an application that can be downloaded on to each mobile device and/or can exist natively on each user's mobile device. The application utilizes languages for each operating system that enable the best performance for each device. The embodied databases of the present invention can use SQL Server and Oracle or any other similar servers. Further embodiments of the application comprise various programming elements such as web services, dynamic for extracting information from the database and storing data in encrypted form queries.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

What is claimed is:

1. A non-transitory computer-readable storage medium comprising programmable instructions adapted to be executed on one or more processors, and to perform a method of:
allowing a plurality of users to register and create their own profiles on a platform server, wherein each user's profile includes at least a business profile and a personal profile;
allowing a first user within the plurality of users to search and have access to a second user's business profile and personal profile, where the second user's business profile and personal profile are found and accessed by the first user through match reference set by the first user, ID search, name search, QR code scan search, email search or combination thereof;
allowing the first user to add the second user to the first user's contact list and make notes regarding the second user;
displaying a countdown bar beside the second user's name in the first user's contact list or on the second user's business profile or personal profile once the first user adds the second user into the first user's contact list, where the countdown bar displays a specified time which the first user needs to initiate a contact with the second user;
allowing the first user to send message to the second user and share news or articles with the second user or allowing the first user to receive message from the second user to initiate the contact; and
archiving the second user from the first user's contact list if the first user did not initiate the contact with the second user within the specified time and the second user did not initiate contact with the first user within the specified time as well.

2. The computer-readable medium of claim 1, wherein the business profile displays at least each user's business photo, name, job title work experience and skill.

3. The computer-readable medium of claim 1, wherein the personal profile displays at least each user's casual photo, interest and personal life information.

4. The computer-readable medium of claim 1, wherein the business profile and the personal profile are displayed via a mobile device and can be switched by a user through business and personal tabs.

5. The computer-readable medium of claim 1, wherein the match reference allows the first user to search other users within the plurality of users based on their distances, expert fields, company sizes, types of business relationship, experiences or combination thereof of.

6. The computer-readable medium of claim 1, wherein the specified time is twenty-four (24), forty-eight (48) or seventy-two (72) hours.

7. The computer-readable medium of claim 1 further comprises:
determining whether to display the second user's business profile first or the personal profile first based on the first user's member status.

8. The computer-readable medium of claim 7, wherein the member status includes poster, networker and fee explorer.

9. The computer-readable medium of claim 1 further comprises:
allowing the first user to search for an event; and
providing the first user with a list of users within the plurality of users who are attending the event.

10. The computer-readable medium of claim 1 further comprises:
providing a calendar that allows the first user to invite the second user to an event and search chronological references to personal relationships.

11. A non-transitory computer-readable storage medium comprising programmable instructions adapted to be executed on one or more processors, and to perform a method of:
allowing a plurality of users to register and create their own profiles on a platform server, wherein each user's profile includes at least a business profile and a personal profile;
wherein the business profile displays at least each user's business photo, name, job title work experience and skill and the personal profile displays at least each user's casual photo, interest and personal life information;
allowing a first user within the plurality of users to have access to a second user's business profile and personal profile, where the second user's business profile and personal profile are found and accessed by the first user through match reference set by the first user, ID search, name search, QR code scan search, email search or combination thereof;
allowing the first user to add the second user to the first user's contact list and make notes regarding the second user;
automatically assigning or allowing the first user to assign the second user into at least one contact group in the first user's contact list based on the second user's business profile or personal profile;
displaying a countdown bar beside the second user's name in the first user's contact list or on the second user's business profile or personal profile once the first user adds the second user into the first user's contact list, where the countdown bar displays a specified time which the first user needs to initiate a contact with the second user;
allowing the first user to send a message to the second user and share news or articles with the second user or allowing the first user to receive a message from the second user to initiate the contact;
wherein the first user can send the message to the second user either directly by individual chat or send the message to the contact group which the second user is assigned, where everyone in the contact group including the second user will receive the message;
archiving the second user from the first user's contact list if the first user did not initiate the contact with the second user within the specified time and the second user did not initiate contact with the first user within the specified time as well.

12. The computer-readable medium of claim 11, wherein the business profile and the personal profile are displayed via a mobile device and can be switched by a user through business and personal tabs.

13. The computer-readable medium of claim 11, wherein the match reference allows the first user to search other users within the plurality of users based on their distances, expert fields, company sizes, types of business relationship, experiences or combination thereof of.

14. The computer-readable medium of claim 11 further comprises:
determining whether to display the second user's business profile first or the personal profile first based on the first user's member status.

15. The computer-readable medium of claim 11 further comprises:
allowing the first user to search for an event; and
providing the first user with a list of users within the plurality of users who are attending the event.

16. The computer-readable medium of claim 11 further comprises:
providing a calendar that allows the first user to invite the second user to an event and search chronological references to personal relationships with other users.

17. A non-transitory computer-readable storage medium comprising programmable instructions adapted to be executed on one or more processors, and to perform a method of:
allowing a plurality of users to register and create their own profiles on a platform server, wherein each user's profile includes at least a business profile and a personal profile;
wherein the business profile displays at least each user's photo, name, job title work experience and skill and the personal profile displays at least each user's photo, interest and personal life, and allows each user to post blogs and news;
allowing a first user within the plurality of users to search and have access to a second user's business profile and personal profile, where the second user's business profile and personal profile are found and accessed by the first user through match reference set by the first user, ID search, name search, QR code scan search, email search or combination thereof;
determining whether to display the second user's business profile first or the personal profile first based on the first user's member status;
allowing the first user to add the second user to the first user's contact list and make notes regarding the second user;
automatically assigning or allowing the first user to assign the second user into at least one contact group in the first user's contact list based on the second user's business profile or personal profile;
displaying a countdown bar beside the second user's name in the first user's contact list or on the second user's business profile or personal profile once the first user adds the second user into the first user's contact list, where the countdown bar displays a specified time which the first user needs to initiate a contact with the second user;
allowing the first user to send message to the second user and share news or articles with the second user or allowing the first user to receive message from the second user to initiate the contact;
wherein the first user can send the message to the second user either directly by individual chat or send the message to the contact group which the second user is assigned, where everyone in the contact group including the second user will receive the message;
archiving the second user from the first user's contact list if the first user did not initiate the contact with the second user within the specified time and the second user did not initiate contact with the first user within the specified time as well; and
allowing the first user to reinitiate contact with the second user after the first user unlocks the achieved connections.

18. The computer-readable medium of claim 17 further comprises:
allowing the first user to search for an event; and
providing the first user with a list of users within the plurality of users who are attending the event.

19. The computer-readable medium of claim 17 further comprises:
providing a calendar that allows the first user to invite the second user to an event and search chronological references to personal relationships with other users.

20. The computer-readable medium of claim 17, wherein the second user is moved to the first user's friend list after the contact is initiated.
